(19) United States
(12) Patent Application Publication
(10) Pub. No.: US 2006/0262343 A1
(43) Pub. Date: Nov. 23, 2006

(54) Data transmitting method, data transmitting program and data transmitting device

(75) Inventors: Yukiko Kikuchi, Kanagawa (JP); Naoharu Kido, Kanagawa (JP); Akihito Toyoda, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/290,799

(22) Filed: Dec. 1, 2005

(30) Foreign Application Priority Data
May 19, 2005 (JP) 2005-146552

(51) Int. Cl. G06F 3/12

(52) U.S. Cl. 358/1.15

(57) ABSTRACT

A data transmitting method includes, inputting address information; comparing the input address information with transmission history information which includes address information with which transmission was executed correctly in a past to determine whether the input address information is correct or not; and transmitting transmission data to an address identified by the input address information through a communication network when it is determined that the input address information is correct.

### BACKGROUND OF THE INVENTION

1. Field of the Invention

The present invention relates to a data transmitting method, a data transmitting program, and a data transmitting device, which are capable of transmitting transmission data such as facsimile data, e-mail, and the like.

2. Description of the Related Art

Recently, according to enforcement of the personal information protection law in Japan, in the data transmitting device such as a facsimile device and the like, security functions, for example, preventing a leakage of security information due to transmission errors, need to be strengthened.

A facsimile device according to a related art which strengthens the security function, for example, is described in JP-A-7-154563.

This facsimile device makes a user input an address number several times, and executes a calling operation only when the input address numbers match with each other. When the address numbers do not match with each other, the facsimile device displays a message indicating that the address numbers do not match with each other and do not executed the calling operation. Accordingly, it is possible to prevent the transmission error due to incorrect address input.

### SUMMARY OF THE INVENTION

However, according to the facsimile device of the related art, if the user inputs wrong address, a transmission can not be properly executed even when the user inputs the address several times.

The present invention has been made in view of the above circumstances and provides a data transmission method, a data transmission program, and a data transmitting device.

According to an aspect of the present invention, there is provided a data transmitting method including: inputting first address information; comparing the first address information with transmission history information to determine whether the first address information is correct or not; and transmitting transmission data to an address identified by the first address information through a communication network when it is determined that the first address information is correct; wherein the transmission history information includes address information with which transmission was executed correctly in a past.

According to another aspect of the present invention, there is provided a storage medium readable by a computer, the storage medium storing a program of instruction executable by the computer to perform a function for data transmitting, the function including: inputting first address information; comparing the first address information with transmission history information to determine whether the first address information is correct or not; and transmitting transmission data to an address identified by the first address information through a communication network when it is determined that the first address information is correct; wherein the transmission history information includes address information with which transmission was executed correctly in a past.

According to further aspect of the present invention, there is provided a data transmitting device including: an input unit that receives address information; a storage unit that stores transmission history information including address information with which transmission was executed correctly in a past; a comparing unit that compares the input address information with the transmission history information to determine whether the input address information is correct or not; and a transmitting unit which transmits transmission data to an address identified by the address information through a communication network when it is determined that the input address information is correct.

### BRIEF DESCRIPTION OF THE DRAWINGS

Embodiments of the present invention will be described in detail based on the following figures, wherein:

FIG. 1 is a block diagram of a multi-function device which adopts a data transmitting device according to a first embodiment of the invention;

FIG. 2 is a view showing a transmission instruction screen according to the first embodiment;

FIG. 3 is a view showing an address re-input screen according to the first embodiment;

FIG. 4 is a view showing a transmission instruction screen according to the first embodiment;

FIG. 5 is a view showing a re-input confirmation screen according to the first embodiment;

FIG. 6 is a flow chart showing operations of a multi-function device according to the first embodiment;

FIG. 7 is a view showing an address designation screen according to a second embodiment;

FIG. 8 is view showing a determination result screen according to the second embodiment.

FIG. 9 is view showing a determination result screen according to the second embodiment.

FIG. 10 is view showing a re-input confirmation screen according to the second embodiment.

FIG. 11 is flowchart showing operations of a multi-function device adopted a data transmitting device according to the second embodiment of the invention.

### DETAILED DESCRIPTION OF THE INVENTION

In this specification, address information identifies an address. The address information may be a telephone number, e-mail address, and so on, and may be displayed by a numeric number, alphabet, symbol, and so on. The address information may be input by using one-touch buttons that the address information is designated to buttons such as A to Z, shortcut buttons that shortcut numbers of the address information are designated to numeric keypads such as 0 to 9, and other numeric keypads. But the address information can be input by using other ways and not limited above-described way. Transmission data includes facsimile data, e-mail, and so on. A communication network includes telephone lines, ISDN, Internet, LAN, and so on and does not make any distinction according to wire or wireless.

### First Embodiment

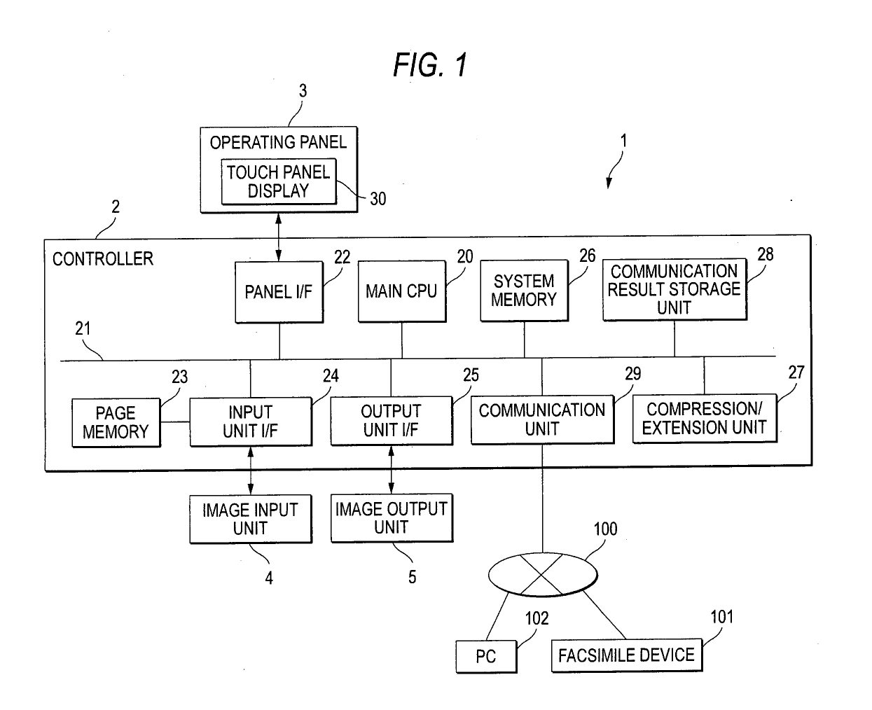

FIG. 1 is a block diagram of a multi-function device which adopts a data transmitting device according to the first embodiment of the present invention. The multi-function device 1 has a plurality of functions such as a copy function, a print function, a scan function, facsimile function, and so on. The multi-function device 1 includes a controller 2 which controls the entire multi-function device 1, an operating panel 3 that inputs data according to an operation of a user, an image input unit 4 which reads the image from an original document and inputs the read image, and an image output unit 5 which prints and outputs the input image on a paper. The multi-function device 1 is connected to a facsimile device 101 and a personal computer (PC) 102 through a communication network 100. Even though only one facsimile device 101 and one PC 102 are shown in FIG. 1, the number of facsimile devices 101 and PCs 102 is not limited.

The ‘copy function’ is a function of printing the image data read by the image input unit (it can be referred to as a scanner) on the paper by the image output unit (it can be referred to as a printing engine). The ‘print function’ is a function of printing the image data transmitted from the PC on the paper by the image output unit. The ‘scan function’ is a function of transmitting the image data read by the image input unit to an designated external device such as the PC. The ‘facsimile function’ is a function of transmitting and receiving the image data through the communication network such as a telephone line.

The operating panel 3 includes a plurality of buttons such as a start button which instructs to start to read the original document or start to facsimile the original document, a cancel button for canceling the copy or facsimile transmission operation, a numeric keypad, and the like. The operating panel 3 further includes a touch panel display 30. The touch panel display 30 includes a display unit such as a liquid crystal display, and an input unit which is overlapped on the display unit. The input operation is executed by pressing a part of the input unit corresponding to a position of each item displayed on the display unit.

The image input unit 4 includes an platen plate that the original document is placed one by one, an ADF (Automatic Document Feeder) which automatically supplies the original document to the platen plate one by one, and an image reading unit which optically reads the image from the original document placed on the platen plate or the original document supplied from the ADF.

The image output unit 5 prints the image on the paper by an electrophotographic process. The electrophotographic process is realized by repeating electrically charging a photo detector, developing, and cleaning. It is preferable that the image output unit 5 adopts an ink-jet method, a thermal transfer method, and so on.

The controller 2 includes a main CPU 20 which controls the controller 2 and the entire multi-function device 1. The main CPU 20 is connected to a panel I/F 22, an input unit I/F 24 that a page memory 23 is connected, an output unit I/F 25, a system memory 26, a compression/extension unit 27, a communication result storage unit 28, and a communication unit 29 through a bus 21.

The panel I/F 22, the input unit I/F 24, and the output unit I/F 25 transmit and receive information to and from the operating panel 3, the image input unit 4, and the image output unit 5, respectively.

The page memory 23 stores the image read by the image input unit 4 in the unit of page through the input unit I/F 24.

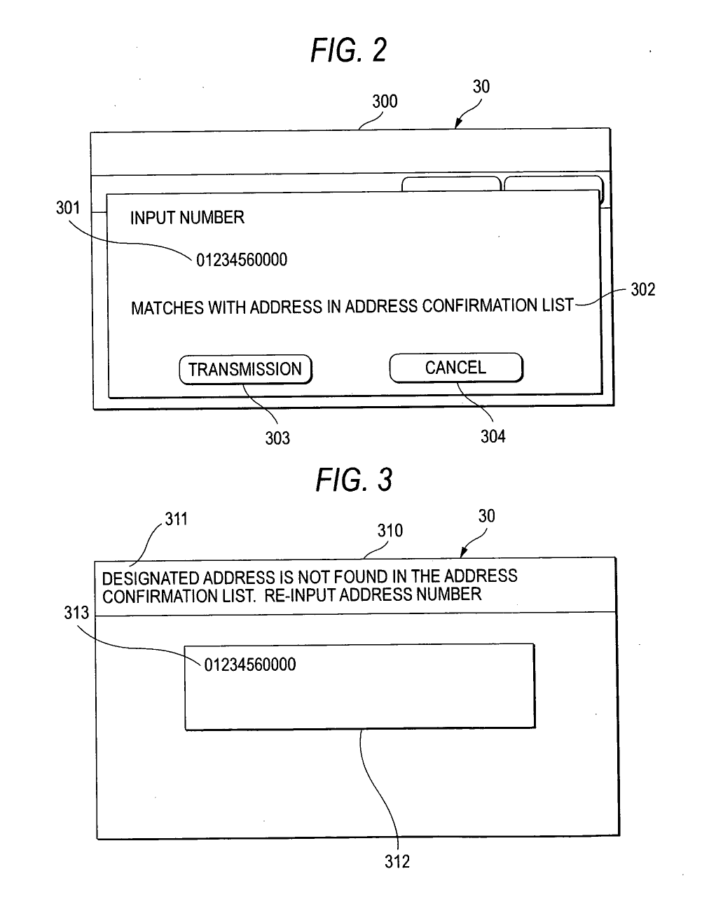

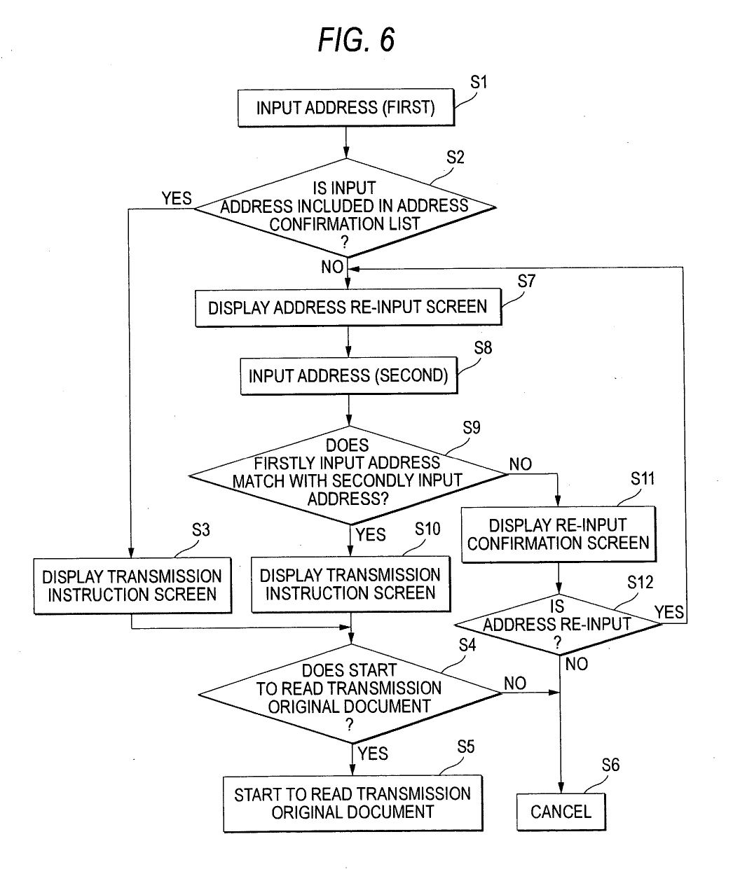

The system memory 26 stores an operation program of the main CPU 20 as shown in FIG. 6 to be hereinafter described, or various data such as screens as shown in FIGS. 2 to 5 to be hereinafter described.

The compression/extension unit 27 compresses the data in the case of transmitting facsimile data and extends the data in the case of receiving the facsimile data.

The communication result storage unit 28 stores an address confirmation list as transmission history information including address numbers as address information with which transmission was executed correctly in a past. The address number is registered in the address confirmation list by the main CPU 20 when the facsimile data is correctly transmitted. However, the address number is deleted by the main CPU 20 when the facsimile data is failed to be transmitted after the registration. The main CPU 20 may delete the address number on the basis of a delete instruction of a user. When the number of the registered address in the address confirmation list reaches to the maximum, the main CPU 20 may delete the oldest address and add the newest address information.

The communication unit 29 is connected to the communication network 100 such as the public line or the network so as to transmit and receive the facsimile data to and from an opponent facsimile device 101. In addition, the personal computer (PC) 102 may utilize the function of the multi-function device 1 through the communication network 100. For example, transmission data created by the PC 102 can be facsimiled by the multi-function device 1.

### Operation of the First Embodiment

Next, the operation of the first embodiment will be described with reference to FIGS. 1 to 5 and based on a flow chart of FIG. 6. FIGS. 2 to 5 show screens being displayed on the touch panel display 30. However, in the following description, an operation of the facsimile function among the plurality of functions of the multi-function device 1 will be described. If nothing is written down, it is regarded that the main CPU 20 executes the corresponding function.

First, the user sets the original document to be transmitted on the ADF of the image input unit 4, and selects a facsimile transmission function in the menu screen displayed on the touch panel display 30 of the operating panel 3. The main CPU 30 of the controller 2 displays the address number input screen (omitted in the drawings) on the touch panel display 30.

If the user inputs desired address number by operating the numeric keypad on the address number input screen (S1), the main CPU 20 compares the input address number with the address confirmation list stored in the communication result storage unit 28, and determines whether the input address number matches with any address number in the address confirmation list (S2). If the input address number matches with the address number in the address confirmation list (S2: Yes), the transmission instruction screen is displayed on the touch panel display 30 (S3).

FIG. 2 shows the transmission instruction screen. In the transmission instruction screen 300, a message indicating that the input address number 301 matches with an address number in the address confirmation list is displayed. Also, in the transmission instruction screen 300, a message 302 for guiding next operation, a ‘transmission’ button 303, and a ‘cancel’ button 304 are displayed.

At this time, if the user presses the ‘transmission’ button 303 on the transmission indication screen 300 shown in FIG. 2 (S4), a CPU of the image input unit 4, which is not shown in the drawing, supplies the original document set in the ADF to the platen plate and makes the image reading unit to read the original document (S5). The read image is stored in the page memory 23 through the input unit I/F 24, compressed by the compression/extension unit 27, and facsimiled to a facsimile device 101 of the other party through the communication network 100 by the communication unit 29.

On the contrary, if the user presses the ‘cancel’ button 304 on the transmission instruction screen 300 shown in FIG. 2, the facsimile transmission process is canceled and the transmission instruction screen 300 is closed (S6).

In the step S2, if the input address number does not exist in the address confirmation list (S2: No), an address re-input screen is displayed on the touch panel display 30 (S7).

FIG. 3 shows the address re-input screen. On the address re-input screen 310, a message 311 which requests to re-input the address such as ‘Input address number, please’ is displayed. If the user re-inputs the address number (S8), the input address number 313 is displayed on the address number displaying area 312 of the address re-input screen 310.

Next, the main CPU 20 determines whether the address number firstly input in the step S1 matches with the address number secondly input in the step S8 (S9). If the firstly input address number matches with the secondly input address number (S9: Yes), the transmission instruction screen is displayed on the touch panel display 30 (S10).

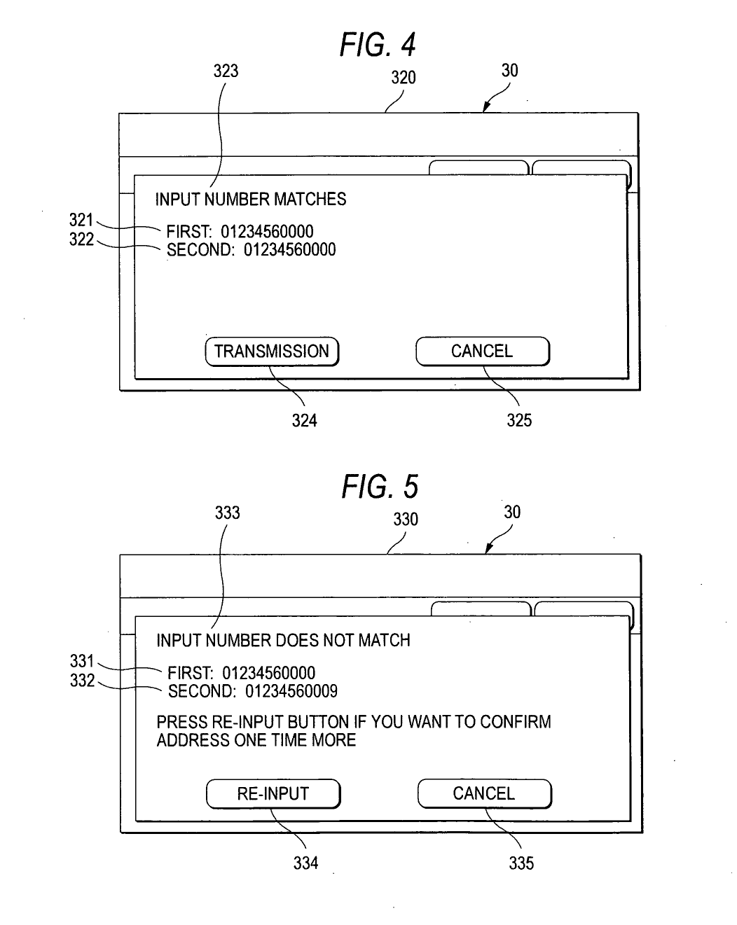

FIG. 4 shows the transmission instruction screen. In the transmission instruction screen 320, a message indicating that the firstly input address number 321 matches with the secondly input address number 322 is displayed. The transmission instruction screen 320 also includes a message 323 for guiding a next operation, a ‘transmission’ button 324, and a ‘cancel’ button 325.

If the user presses the ‘transmission’ button 324 on the transmission instruction screen 320 shown in FIG. 4 (S4: Yes), the image input unit 4 reads an original document to be transmitted as described above (S5) and the communication unit 29 facsimiles the original document. If the user presses the ‘cancel’ button 325, the facsimile transmission is canceled and the transmission instruction screen 320 is closed (S6).

In the step S9, if the firstly input address number does not match with the secondly input address number (S9: No), a re-input confirmation screen is displayed on the touch panel display 30 (S11).

FIG. 5 shows the re-input confirmation screen. In the re-input confirmation screen 330, a message indicating that the firstly input address number 331 does not match with the secondly input address number 332 is displayed. The re-input confirmation screen 330 also includes a message 333 for guiding next operation, a ‘re-input’ button 334 and a ‘cancel’ button 335.

If the user presss the ‘re-input’ button 334 on the re-input confirmation screen 330 shown in FIG. 5 (S12: Yes), the process returns to the step S7 and the address re-input screen 310 shown in FIG. 3 is displayed so as to proceed following operations. If the user presses the ‘cancel’ button 335 (S12: No), the facsimile transmission process is canceled and the re-input confirmation screen 330 is closed (S6).

### Effect of the First Embodiment

According to the first embodiment, the input address number is compared with the address confirmation list including address number with which transmission was executed correctly in a past so that the input address number can be determined whether it is correct or not. Accordingly, the transmission error due to the wrong address can be surely prevented. In the case that the input address number does not exist in the address confirmation list, the wrong input can be prevented because the user has to input the address number twice.

### Second Embodiment

Next, a multi-function device according to the second embodiment of the invention will be described. In the second embodiment, comparing to the first embodiment, the multi-function device includes a function capable of simultaneously transmitting the data to a plurality of des tinations and includes the entire configuration shown in FIG. 1 as the same with the first embodiment. Accordingly, the same parts are represented by the same reference numerals, and the descriptions thereof will be omitted.

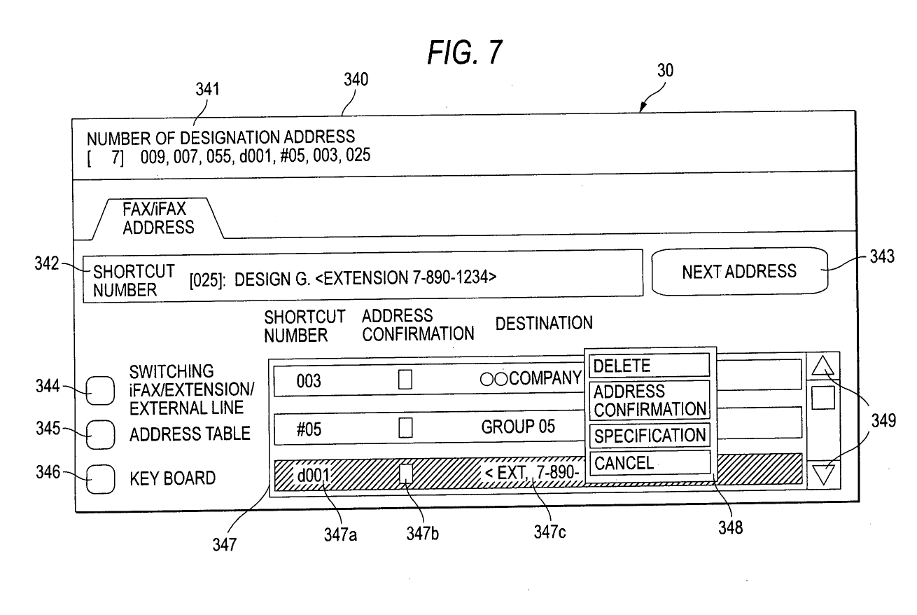

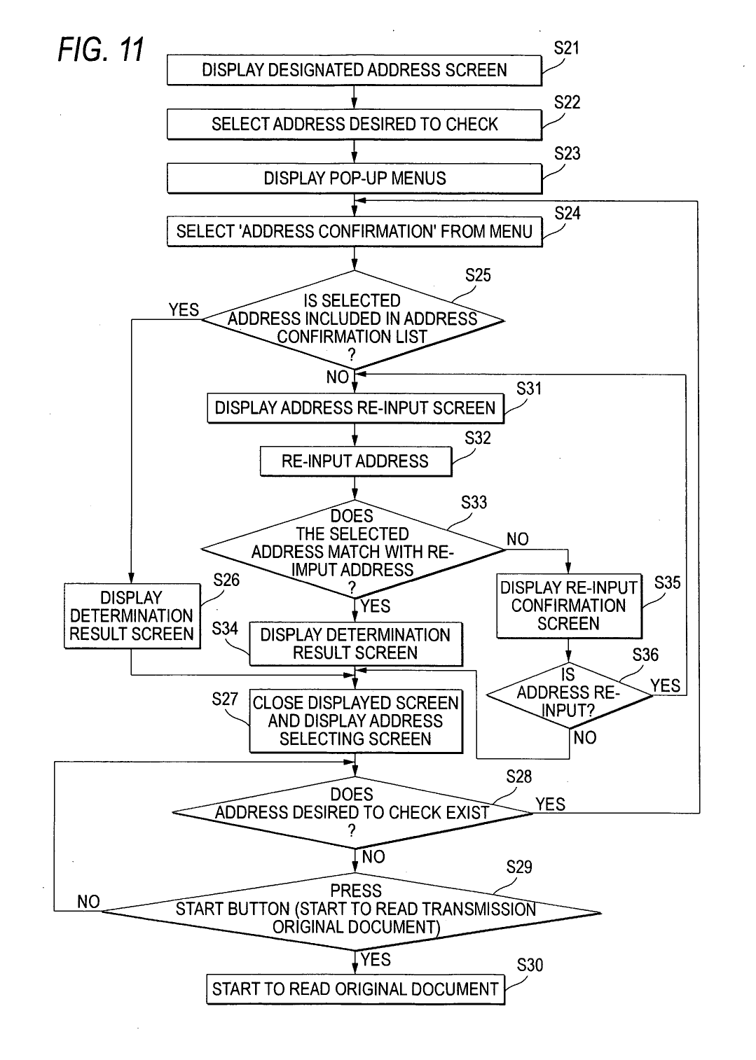

A system memory 26 according to the second embodiment stores an operation program of the main CPU 20 as shown in a flowchart of FIG. 11 which will be described below and various data such as screens as shown in FIGS. 7 to 11 which will be described below.

### Operation of the Second Embodiment

Next, referring to FIG. 1, FIG. 3, and FIGS. 7 to 10, the operation of the second embodiment will be described based on a flowchart in FIG. 11. FIGS. 7 to 10 show screens displayed on the touch panel display 30. In the operation described hereinafter, if nothing is written down, it is regarded that the main CPU 20 executes the corresponding operation.

First, the user sets the original document to be transmitted on the ADF of the image input unit 4 and selects a facsimile transmission function from a menu being displayed on the touch panel display 30 of the operating panel 3. The main CPU 20 of the controller 2 displays the address designation screen on the touch panel display 30 (S21).

(Address Designation Screen)

FIG. 7 shows the address designation screen. The address designation screen 340 is a screen for designating the address of the fax/internet fax (iFAX) and can simultaneously transmit transmission data to a plurality of addresses by designating a plurality of addresses. The address designation screen 340 includes an address history displaying area 341, an address inputting area 342, a ‘next address’ button 343, ‘switching iFAX/extension/external line’ button 344, an ‘address table’ button 345, a ‘keyboard’ button 346, an address list 347, a pop-up menu 348, a scroll button 349, and so on.

Hereinafter, the address designation screen 340 will be described in detail.

The ‘switching iFAX/extension/external line’ button 344 switches the kind of the line. The ‘address table’ button 345 displays the address table that a shortcut registration number is displayed as a button which can display or detect the address table and designate the address. The ‘keyboard’ button 346 displays a keyboard screen on the touch panel display 30 in order to designate the address.

In the address history displaying area 341, setting number (7) of the corresponding address is displayed and the history of the designated address is sequentially displayed from the left. For example, 3 digits such as (009), (007), and (005) indicate that the shortcut number is designated, (d001) indicates that a full dial is designated, and (#05) indicates that a group dial is designated.

The address inputting area 342 indicates the address being input, for example, as shown in FIG. 7, if the user presses number 25 as the shortcut number by operating the ‘address table’ button 345, contents (address name, and the like) registered in the shortcut number 25 are displayed in the address inputting area 342. In addition, if the user inputs the ‘keyboard’ button 346 or dial ‘11111’ by using the numeric keypad, the ‘11111’ is displayed in the address inputting area 342.

The ‘next address’ button 343 is used when inputting the next address in the address inputting area 342 after inputting the address in the address inputting area 342.

The address list 347 displays the addresses, designated by being input in the address inputting area 342, according to a reverse chronological order from above.

The address displayed in the address inputting area 342 is added in top of the address list 347 by pressing the ‘next address’ button 343 and then the address inputting area 342 becomes a blank. As shown in FIG. 7, if the user presses the ‘next address’ button 343, contents of the shortcut number 25 are added to top of the address list 347. The address list 347 is displayed by moving the triangle scroll button 349 in the right upward and downward. A check-box 347b for ‘address confirmation’ in the address list 347 is checked when the designated address matches with an address in the address confirmation list.

The address list 347 includes a shortcut number 347a, the check-box 347b for address confirmation, an address name (in case where the address name is registered) 347c, and address number.

If the user selects an address desired to check displayed on the address list 347, the selected address is highlighted and a pop-up menu 348 corresponding to the selected address is displayed while being overlaid in front of the address list 347. In an embodiment shown in FIG. 7, the full dial (d001) is selected. In the pop-up menu 348, by pressing a ‘delete’ button, the selected address is deleted while the corresponding address is deleted from the address history displaying area 341. An ‘address confirmation’ button is for checking an input error of the selected address. A ‘specification’ button is for displaying the address name of the selected address (in case that the address name is registered) and full digits of the address number. A ‘cancel’ button is for canceling the selection of the address.

If the user selects an address desired to check among the addresses displayed on the address list 347 of the address designation screen 340 (S22), the main CPU 20 displays the pop-up menu 343 on the address designation screen 340 (S23).

If the user selects the ‘address confirmation’ at the pop-up menu 348 (S24), the main CPU 20 compares the selected address number with the address confirmation list stored in the communication result storage unit 28 and determines whether an address number which matches with the selected address number exists in the address confirmation list (S25). If the address number matching with the selected address number exists (S25: Yes), the check-box 347b of the ‘address confirmation’ at the address list 347 is checked with a check mark and a determination result screen is displayed on the touch panel display 30 (S26).

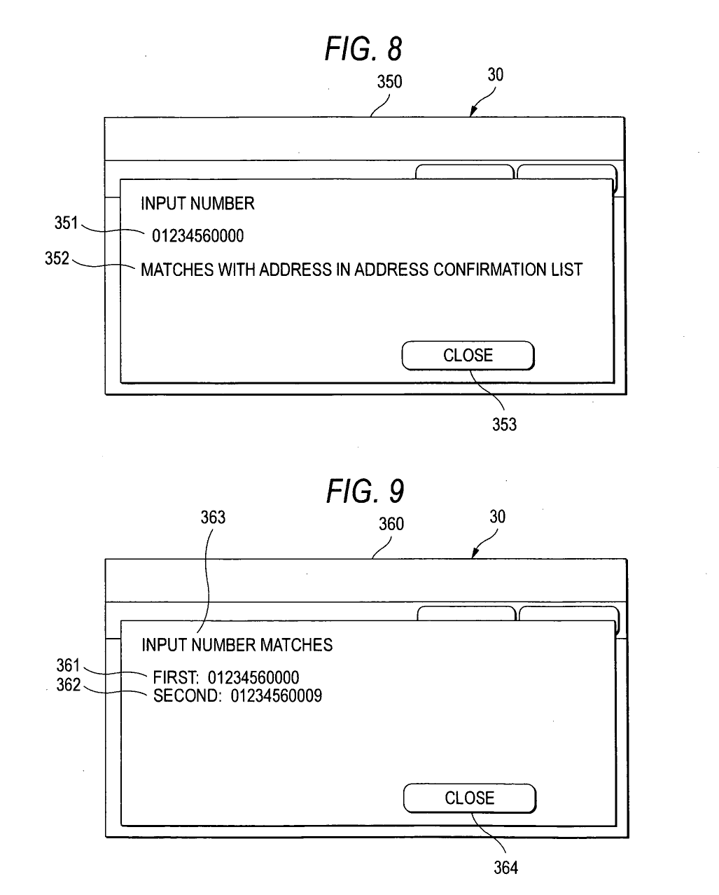

FIG. 8 shows a determination result screen. The determination result screen 350 includes a selected address number 351, a message 352 which indicates that the selected address number matches with an address number in the address confirmation list, and a ‘close’ button 353.

If the user presses the ‘close’ button 352 on the determination result screen 350, the main CPU 20 closes the determination result screen 350 and displays the address designation screen 340 shown in FIG. 7 on the touch panel display 30.

When the address number desired to check does not exist (S28: No), if the user presses the start button which is not shown in the operating panel 3 (S29: Yes), the CPU which is not shown in the image input unit 4 supplies the original document set on the ADF to the platen plate and makes the image reading unit read the original document (S30). The read image is stored in the page memory 23 through the input unit I/F 24, compressed by the compression/extension unit 27, and facsimiled to the opponent facsimile device 101 through the communication network 100.

In step S25, if the address number matching with the selected address number does not exist (S25: No), the address re-input screen 310 shown in FIG. 3 is displayed on the touch panel display 30 (S31).

If the user inputs the address number again (S32), the main CPU 20 determines if the address number selected in step S22 matches with the address number input in the step S32 (S33). If the address number selected in the step S22 matches with the address number input in the step S32 (S33: Yes), the determination result screen is displayed on the touch panel display 30 (S34).

FIG. 9 shows the determination result screen. The determination result screen 360 includes a message 363 which indicates that a firstly input (selected) address number 361 matches with a secondly input address number 362, and a ‘close’ button 364.

If the user presses the ‘close’ button 364 on the determination result screen 360, the above-described steps S27 to S30 are executed.

In step S33, if the firstly input (selected) address number does not match with the secondly input address number (S33: No), a re-input confirmation screen is displayed on the touch panel display 30 (S35).

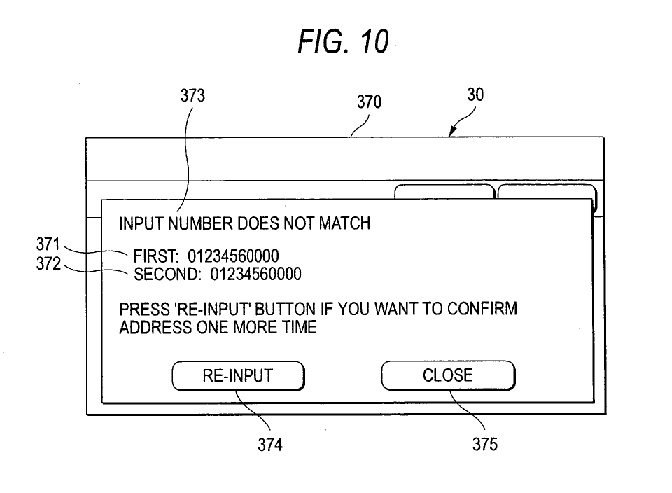

FIG. 10 shows the re-input confirmation screen. The re-input confirmation screen 370 includes a message 373 which indicates that a firstly input address number 371 does not match with a secondly input address number 372, a message 373 for guiding next operation, a ‘re-input’ button 374, and a ‘close’ button 375.

If the user presses the ‘re-input’ button 374 on the re-input confirmation screen 370 (S36: Yes), the process proceeds to step S31. If the user presses the ‘close’ button 375, the process proceeds to the step S27 and after.

In addition, it is preferable that only checked address number among a plurality of address numbers designated for simultaneous transmission may be transmitted as well as non-checked address number. In this case, the start button can be pressed at any time and it is preferable that the non-checked number or the non-checked address number may be indicated when pressing the start button and be transmitted to the user.

### Effect of the Second Embodiment

According to the second embodiment, if the user selects any one of the address number, the user can confirm only the address number desired to check so that the operability is improved. Because the address number can be simultaneously transmitted to a plurality of destinations by one input operation, the transmitting operation is easily executed and the transmission error can be prevented.

In addition, the present invention is not limited to the above-described embodiments and can be implemented in different forms without departing from the scope and sprit of the present invention.

For example, in each of the embodiments, even though the facsimile transmission is described, the invention can be applied to the e-mail transmission.

In addition, in each of the above-described embodiments, even though the invention is applied to the multi-function device, the invention can be applied to a facsimile dedicated device, a PC, and so on.

According to the embodiments of the invention, transmission error due to the wrong address can be certainly prevented because the input address information is compared with the transmission history information including the address information with which transmission was executed correctly in a past, and the input address information is determined whether it is correct or not.

The entire disclosure of Japanese Patent Application No. 2005-146552 filed on May 19, 2005 including specification, claims, drawings and abstract is incorporated herein by reference in its entirety.

What is claimed is:

1. A data transmitting method comprising:
inputting first address information;
comparing the first address information with transmission history information to determine whether the first address information is correct or not; and
transmitting transmission data to an address identified by the first address information through a communication network when it is determined that the first address information is correct;
wherein the transmission history information includes address information with which transmission was executed correctly in a past.

2. The data transmitting method according to claim 1, further comprising:
inputting second address information when it is determined that the first address information is not correct; and
comparing the first address information with the second address information.

3. The data transmitting method according to claim 1, further comprising:
receiving an instruction, which indicates executing or canceling the transmitting of the transmission data, when it is determined that the first address information is correct;
wherein the transmitting of the transmission data is executed when the instruction indicates executing the transmitting of the transmission data.

4. The data transmitting method according to claim 2, further comprising:
receiving a first instruction or a second instruction when the comparing shows that the first address information is not identical with the second information address;
wherein when the first instruction is received, data transmitting is canceled; and
wherein when the second instruction is received, the second address information is input again.

5. The data transmitting method according to claim 1,
wherein the inputting of the first address information includes selecting address information from a plurality of address information registered in advance.

6. The data transmitting method according to claim 1,
wherein the first address information includes plural pieces of first address information; and
wherein, in the transmitting of the transmission data, the transmission data is simultaneously transmitted to addresses identified by at least a part of the plural pieces of first address information, which is determined correct.

7. The data transmitting method according to claim 1, further comprising:
inputting plural pieces of address information;
wherein the inputting of the first address information includes designating at least one of the plural pieces of address information to input the designated address information as the first address information.

8. The data transmitting method according to claim 1,
wherein the transmitting of the transmission data includes:
scanning an original document to obtain image data when it is determined that the first address information is correct; and
transmitting the image data as the transmission data.

9. The data transmitting method according to claim 1, wherein the inputting of the first address information is executed when data transmission function is selected from a plurality of functions including, the data transmitting function, a copy function, a print function, a scan function.

10. A storage medium readable by a computer, the storage medium storing a program of instruction executable by the computer to perform a function for data transmitting, the function comprising:
inputting first address information;
comparing the first address information with transmission history information to determine whether the first address information is correct or not; and
transmitting transmission data to an address identified by the first address information through a communication network when it is determined that the first address information is correct;
wherein the transmission history information includes address information with which transmission was executed correctly in a past.

11. A data transmitting device comprising:
an input unit that receives address information;
a storage unit that stores transmission history information including address information with which transmission was executed correctly in a past;
a comparing unit that compares the input address information with the transmission history information to determine whether the input address information is correct or not; and
a transmitting unit which transmits transmission data to an address identified by the address information through a communication network when it is determined that the input address information is correct.
